(19) United States
(12) Patent Application Publication
(10) Pub. No.: US 2006/0141090 A1
(43) Pub. Date: Jun. 29, 2006

(54) Method for production of a hollow body by extrusion and blowing of a thermoplastic resin

(75) Inventor: Michel Lahouati, Le Mesnil Thomas (FR)

Correspondence Address: YOUNG & THOMPSON, 745 SOUTH 23RD STREET, 2ND FLOOR, ARLINGTON, VA, 22202, US

(73) Assignee: EUROFEU SOCIETE ANONYME, LE MESNIL THOMAS (FR)

(21) Appl. No.: 10/544,221

(22) PCT Filed: Feb. 3, 2004
(86) PCT No.: PCT/FR04/00237

§ 371 Date: Aug. 2, 2005

(30) Foreign Application Priority Data
Feb. 7, 2003 (FR) 03/01447

(51) Int. Cl. B29C 47/00

(52) U.S. Cl. 425/326.1

(57) ABSTRACT

A method for production of a hollow body by extrusion and blowing of a thermoplastic resin, includes the steps of filling a quantity of resin into an accumulator (1) which has an accumulation chamber (12) with an open end, placing a blowing mould (24) with an internal cavity (36) and a constricting section (37) in communication with the open end, axially displacing a core (10, 11) across the constriction point of the internal cavity such as to cover a projecting part of the core with a layer of resin (38), continuing the axial displacement of the core in the internal cavity (36) to axially extend the layer of resin (38) and applying a fluid pressure to the internal surface of the resin layer through the core to obtain a hollow body.

The present invention relates to a method of manufacturing a biaxially oriented hollow body by extrusion blow molding of a thermoplastic resin and to a device for implementing this method.

Document EP 486 419 describes such a method, which comprises the steps consisting in bringing the resin into a malleable state, filling an accumulator with a quantity of said resin, said accumulator having an accumulation chamber defined between a central core and an outer wall having an end opening, placing a blowing mold with an internal cavity having an open constriction in communication with said end opening, axially displacing a moveable mandrel from said central core through said accumulation chamber, said end opening and said constriction of the internal cavity, so as to coat a portion of the mandrel projecting from said central core with a layer of resin.

In this known method, the resin is then blow-molded. This method proves to be advantageous in terms of productivity and allows the temperature of the resin to be controlled and made uniform, thus preventing weight and size irregularities in the hollow body obtained. However, this known method is not suitable for the manufacture of hollow bodies of large capacity, since there is a risk of the parison becoming detached from the mandrel during the blowing step if said parison has too great a weight. It is known to use a high-molecular-weight thermoplastic resin in order to prevent the risk of parison detachment. However, such a resin has a high glass transition temperature, requiring greater energy consumption in the molding machine. In addition, such a resin does not always have mechanical properties suitable for the application of the hollow body. Finally, this known method makes it possible to manufacture only hollow bodies of simple structure, it being possible for only the external form to be adapted by the choice of shape of the blowing mold.

The object of the present invention is to manufacture a biaxially oriented hollow body that remedies these drawbacks.

To do this, the invention provides a method of the abovementioned type, characterized by the steps consisting in:

continuing the axial displacement of the moveable mandrel in said internal cavity at least as far as an intermediate level between said open constriction and an opposite end wall of said internal cavity, simultaneously pushing the resin out of said accumulation chamber with an output speed that is lower than the displacement speed of the mandrel, in order to stretch said layer of resin axially;

applying fluid pressure to said inner surface of the layer of resin through said mandrel in order to stretch said layer of resin transversely as far as the walls of said internal cavity and obtain a biaxially oriented hollow body having a neck corresponding to the constriction of the internal cavity; and

letting said hollow body cool down to a rigid state, retracting said mandrel and ejecting said hollow body from the blowing mold.

In this method, a layer of resin coats the moveable mandrel at least as far as an intermediate level between the constriction and the end wall of the mold cavity, so as to form a parison directly in the blowing mold, thereby making it possible to carry out the blowing step immediately afterwards, without changing work station. The continuity and speed of execution of these two steps avoids problems in the thermal conditioning of the resin. This method operates with most commercially available resins such as, for example, PVC, polypropylene PP, polyethylenes PE, PET and polyamides PA. Thus, a biaxially oriented hollow body is obtained without a weld with a wall free of inhomogeneities or other point defects. The use of a coated mandrel allows a parison of large mass to be produced without any risk of parison detachment, thereby making it possible to obtain a hollow body of large capacity and/or with a large wall thickness. The mandrel fulfills both the parison stretch function and the parison support function.

Preferably, the method according to the invention comprises the step consisting in impressing an external relief of the projecting portion of said mandrel onto an inner surface of said layer of resin so as to obtain a hollow body having a corresponding internal relief. For example, the projecting portion of the mandrel includes grooves and/or parts having different transverse dimensions and/or a thread.

According to one particular embodiment of the invention, said external relief includes at least one threaded mandrel portion for obtaining a corresponding thread on the inner surface of said hollow body. The thread obtained on the inner surface of the hollow body has the advantage of providing a pressure-resistant attachment for a plug, a valve or a similar accessory that has to be fitted into the neck of the hollow body.

Advantageously in this case, said moveable mandrel comprises a peripheral sleeve that constitutes said threaded mandrel portion and a central rod that can slide axially relative to said peripheral sleeve. In the displacement step of the mandrel, said peripheral sleeve is brought into said constriction of the internal cavity so as to clamp said layer of resin between said threaded mandrel portion and a wall of said constriction, and, in the retraction step of the mandrel, said peripheral sleeve is made to undergo an axial rotational movement so as to disengage said peripheral sleeve from the internal thread obtained in a corresponding constriction of the hollow body.

The use of a mandrel made in two portions, namely a central rod and a threaded peripheral sleeve, makes it possible to control the movements of the threaded mandrel portion independently. The peripheral sleeve surrounds the central core so that the gap between the mandrel and the constriction of the mold is reduced when the peripheral sleeve is introduced into the constriction. The layer of resin clamped between the two parts forms the neck of the hollow body and is shaped, on its inner surface, to the thread of the peripheral sleeve. The internal thread may also be formed in another portion of the hollow body, for example in the end wall using a corresponding relief on the end portion of the central rod.

Advantageously, the end opening of the accumulator and the constriction of the blowing mold communicate through an extrusion orifice of an extrusion die and, for example at the end of the displacement step of the moveable mandrel, a compacting sleeve is moved around said mandrel in said extrusion orifice, said compacting sleeve being inserted between said mandrel and a wall of said extrusion orifice so as to completely remove the resin from the extrusion orifice in the internal cavity of the blowing mold. Thus, the hollow bodies are obtained with a neck containing no sink marks.

Preferably, the method according to the invention furthermore includes the steps consisting in: displacing the peripheral sleeve from the constriction toward the interior of the internal cavity during the blowing step, so as to fold a flat of said layer of resin between a portion of said layer of resin pressed against the wall of the internal cavity of the blowing mold and an end portion of said layer of resin fastened to the peripheral sleeve; and pressing said folded flat against said end portion of said layer of resin fastened to the peripheral sleeve at the end of the blowing step. Thus, a double-walled neck is obtained, giving it greater rigidity. This neck is provided with an internal thread for the attachment of a plug or the like. The pressure resistance of the corresponding assembly is also increased.

Advantageously, in the displacement step of the moveable mandrel, the accumulation chamber is completely emptied through the extrusion orifice. Complete removal from the accumulator allows precise control of the quantity of resin that is molded, for precise dimensional control of the walls of the hollow body obtained, at a set maintained temperature.

The axial displacement of the mandrel is carried out according to the desired degree of stretch. In one particular embodiment of the invention, the mandrel is displaced substantially as far as the end wall of the internal cavity.

The invention also provides a device for implementing this method, which comprises:

a resin accumulator that includes an outer wall and a central core that define, between them, an accumulation chamber capable of receiving a thermoplastic resin in a malleable state, an end opening made through said outer wall, an extrusion ram arranged so as to slide between said outer wall and said central core in order to expel the resin from said accumulation chamber through said end opening;

a biaxial-orientation blowing mold with an internal cavity having an open constriction that can be placed opposite said end opening and an end wall on the opposite side from said open constriction;

a mandrel that can move axially between a retracted position inside said central core and projection positions, in which positions a portion of said mandrel projecting from said central core is engaged through said end opening and said constriction of the internal cavity, said mandrel having an axial internal duct opening onto the outside of said mandrel at said projecting portion and a valve for selectively opening and closing said internal duct;

controlled drive means for selectively displacing, so as to slide axially, said extrusion ram and said mandrel; and

a pressure source connected to said internal duct of the mandrel,

characterized in that said mandrel can move in said internal cavity at least as far as an intermediate level between said constriction and said end wall.

Advantageously, said mandrel has at least one groove for obtaining a rib of corresponding shape on the inner surface of said hollow body.

According to particular embodiments, said groove or each of said grooves follows a closed annular path or a substantially linear axial path or a helical path.

Preferably, said mandrel includes at least one threaded mandrel portion for obtaining a corresponding thread on the inner surface of said hollow body.

Advantageously, the moveable mandrel comprises a peripheral sleeve that constitutes said threaded mandrel portion and a central rod that can slide axially relative to said peripheral sleeve, and said drive means are capable of axially displacing said central rod and said peripheral sleeve so as not to be in phase and of rotating at least said peripheral sleeve in the unscrewing direction of the thread of the peripheral sleeve.

According to one particular embodiment of the invention, the central rod is rotated axially by said drive means, a unidirectional coupler being placed between said peripheral sleeve and said central rod in order to rotationally couple said peripheral sleeve to said central rod in said unscrewing direction and to rotationally decouple said peripheral sleeve from said central rod in the opposite direction.

Preferably, the end opening of the accumulator and the constriction of the biaxial-orientation blowing mold communicate through an extrusion orifice of an extrusion die, a compacting sleeve being placed around said mandrel and able to move axially between a retracted position in said central core of the accumulator and a deployed position, in which position said compacting sleeve is inserted between said mandrel and a wall of said extrusion orifice so as to completely remove the resin from the extrusion orifice in the internal cavity of the biaxial-orientation blowing mold.

Advantageously, the outer wall of the accumulator is provided with a heating means and the central core of the accumulator is provided with an internal circuit intended for the circulation of a heat-transfer fluid. With these features, the temperature of the resin in the accumulator is regulated from both faces of the accumulation chamber. The resin may thus be maintained at a uniform temperature optimal for the molding. For example, the heating means is an electrical resistor. Any other type of heating means may be provided on or in the outer wall of the accumulator and on or in the central core in order for the resin to be thermally regulated simultaneously from the inner peripheral surface and the outer peripheral surface of the accumulation chamber.

The invention will be better understood, and other objects, details, features and advantages thereof will become more clearly apparent, over the course of the following description of several particular embodiments of the invention, given solely by way of illustration but implying no limitation, with reference to the appended drawings. In these drawings:

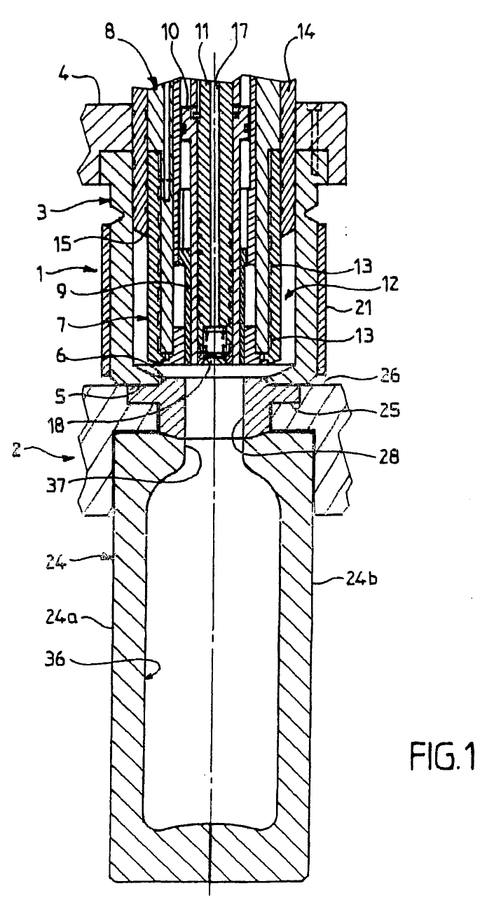

FIG. 1 is a partial view in axial section of a device according to a first embodiment of the present invention, the accumulator being associated with a molding station;

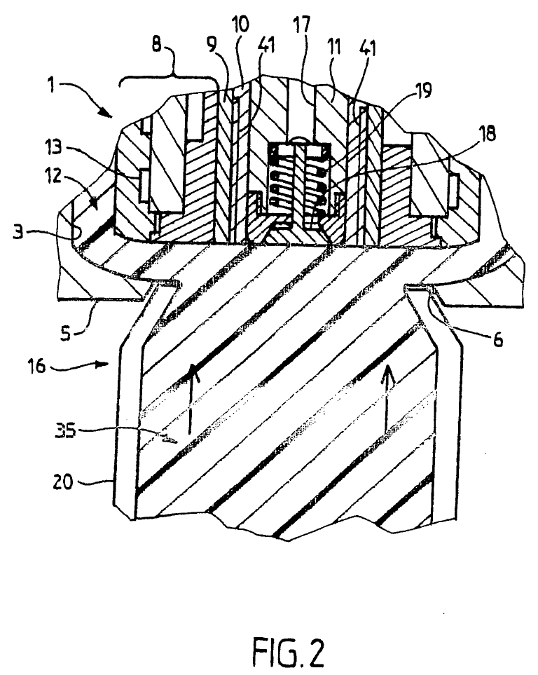

FIG. 2 is an enlarged detail of part of the accumulator of FIG. 1, the accumulator being associated with an injection station;

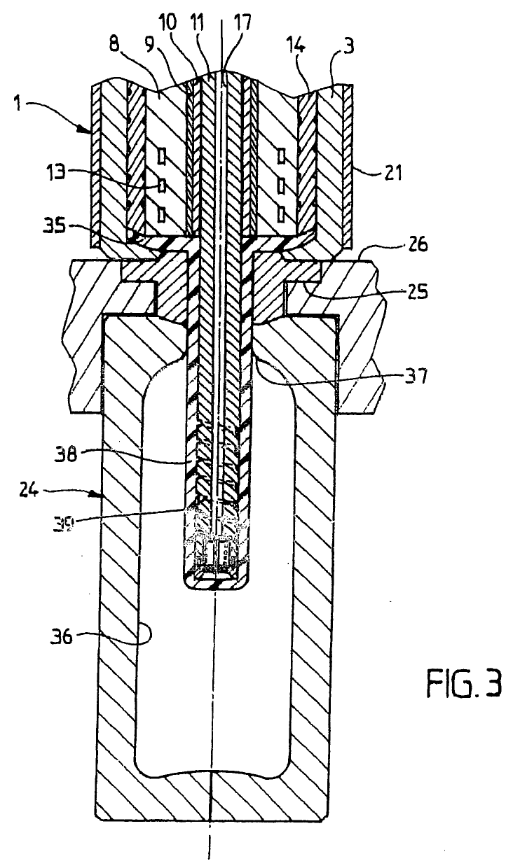

FIG. 3 is a view similar to FIG. 1, showing an extrusion step with a coating of the mandrel;

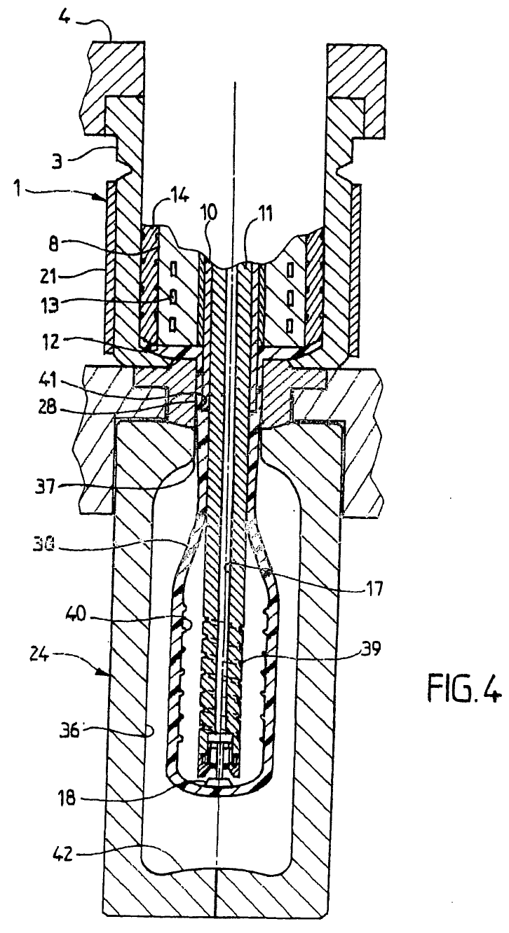

FIG. 4 is a view similar to FIG. 3, showing a biaxial orientation step with preblowing;

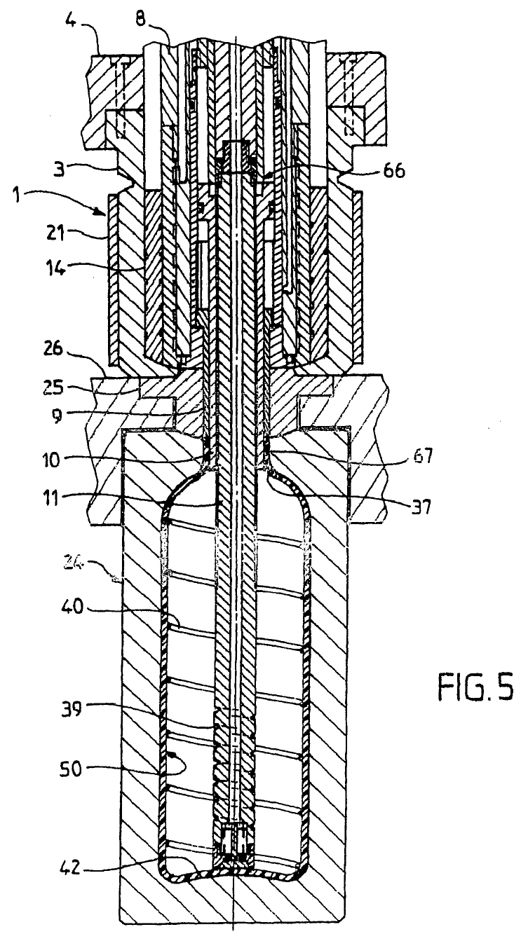

FIG. 5 is a view similar to FIG. 4, showing the end of the blowing step;

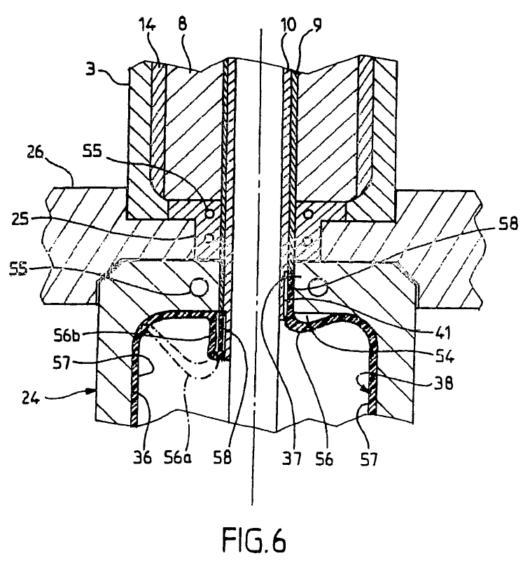

FIG. 6 is an enlarged detail of a device according to a second embodiment of the present invention, the accumulator being associated with a molding station;

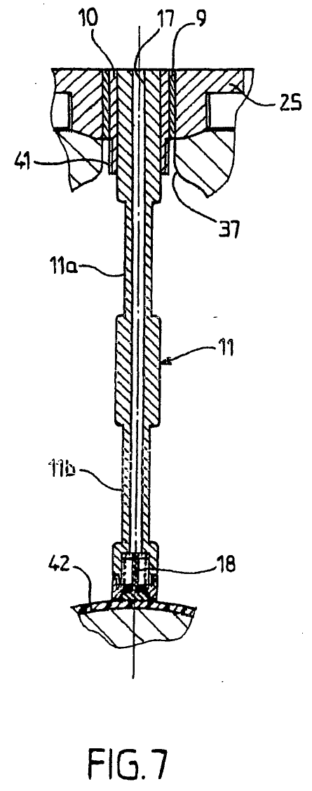

FIG. 7 is a partial view showing an alternative embodiment of the mandrel;

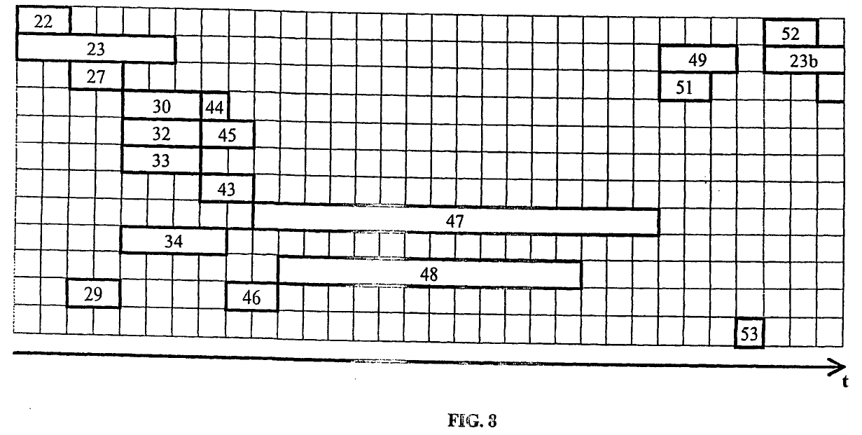

FIG. 8 is a diagram showing the timing of the operating steps of the device of FIG. 1; and

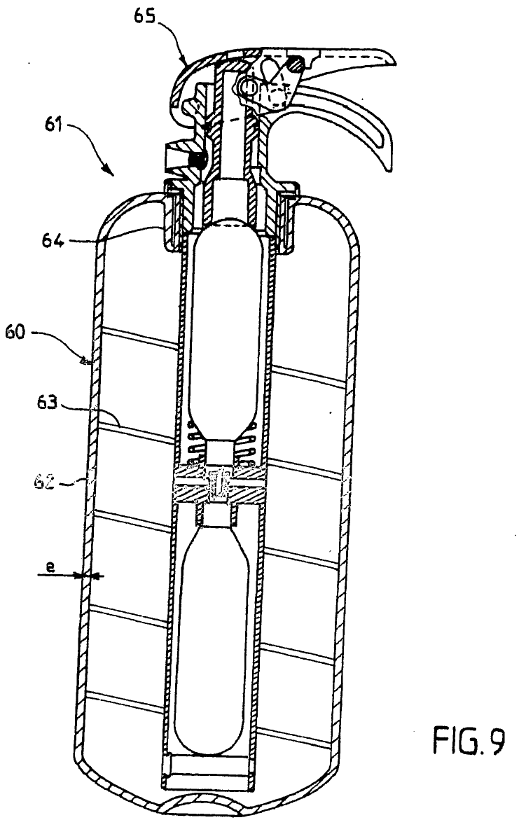

FIG. 9 shows an example of a hollow body obtained using the device of FIG. 6.

A molding machine for extrusion blow molding according to the first embodiment of the invention and its operation will now be described.

Referring to FIG. 1, the machine comprises an accumulator 1 that is mounted on a moveable support in order to be able to be associated with two different work stations. In FIG. 1, the accumulator 1 is associated with a molding station 2.

The accumulator 1 comprises a tubular outer casing 3 fixed at its upper end to a support flange 4. The support flange 4 forms part of a turntable, known per se but not shown, for moving the accumulator 1 from one work station to the other. The outer casing 3 has, at its lower end, a transverse rim 5 that surrounds and defines an output opening 6 of the accumulator 1. Inside the outer casing 3 is a central core 7 formed from several coaxial parts that can move relative to one another, namely an inner jacket 8, a compacting sleeve 9, a threaded sizing sleeve 10 and a central hollow rod 11. The inner jacket 8 comprises several individual parts that contain a circuit for the circulation of a heat-transfer fluid, such as thermal oil. The circuit comprises annular ducts 13 made near the outer surface of the inner jacket 8. The sizing sleeve 10 and the central hollow rod 11 constitute a coating mandrel, the function of which will be explained below.

Between the central core 7 and the internal wall of the outer casing 3 is an accumulation chamber 12 that extends as far as the output opening 6 and comprises an annular chamber closed at its upper end 15 by an extrusion ram 14. In FIG. 1, the extrusion ram 14, the inner jacket 8, the compacting sleeve 9, the sizing sleeve 10 and the central hollow rod 11 are shown in a retracted position inside the outer casing 3. These various parts may be moved axially toward the outside of the outer casing 3 by a conventional pneumatic drive system.

With reference to FIG. 2, the central rod 11 has a central duct 17 that is connected at the upper end to a compressed air source (not shown) and is closed at the lower end by a spring-loaded valve 18 returned to the closure position by a spring 19.

In FIG. 2, the accumulator 1 is shown associated with the other work station, which is an injection station 16. The manufacturing cycle for a hollow body starts with this station, as will now be explained.

At the injection station 16, a screw injection machine of known type is used for bringing a thermoplastic resin into a malleable state and for injecting it into the accumulation chamber 12. FIG. 2 shows only an end portion of the injection nozzle 20, which fits against the outer casing 3 of the accumulator 1. A predetermined quantity of resin 35 is thus injected into the accumulator 1 so as to fill the accumulation chamber 12. To bring the resin 35 to the optimum temperature for the biaxial-orientation molding phase and to maintain it thereat, the temperature in the accumulation chamber 12 is regulated by means of an electrical resistor 21 and the circulation of a fluid in the circuit of the inner jacket 8.

Thus, the accumulator 1 serves both for precise metering of the quantity of resin needed to obtain a given hollow body and for precise thermal conditioning of the material to be molded. This accumulator, with two thermal conditioning surfaces, allows any type of plastic to be converted within very broad thermoplastic and thermoelastic temperature ranges. In addition, the material is conditioned in the accumulator without maintaining the internal tension due to injection. Finally, the thermal conditioning in the accumulator of the material to be molded helps to prevent sink marks due to the material cooling prematurely.

On the basis of this situation, the operation of the machine will be explained with the aid of the diagram shown in FIG. 8, in which each horizontal step represents a time step of about 0.5 s.

At step 22, the accumulator 1 is moved by the support turntable to the biaxial-orientation molding station 2, which can be seen in FIGS. 1 and 3 to 5. A cover (not shown) closes off the opening 6 during this movement. In FIG. 1, the material contained in the accumulation chamber 12 is not shown.

The biaxial-orientation/molding station 2 comprises an extrusion die 25, fixed to a stationary support plate 26, and a blowing mold 24 consisting of two separate shells 24a and 24b. The shells 24a and 24b are actuated in a transverse movement by a conventional mechanism for opening and closing the mold 24. The mold 24 contains an internal cavity 36 that has a constriction 37 of diameter equal to the diameter of the orifice 28 of the extrusion die 25. Step 23, which starts at the same time as step 22, represents the closure movement of the mold 24. Since this movement is known, the mold 24 is shown in the closed position in all the figures. Step 27 represents the locking of the support turntable to the station 2. The rim 5 is then positioned so as to fit against the upper surface of the extrusion die 25, the accumulator 1 being placed along the axis of the extrusion orifice 28. Step 29 represents the opening of the cover that was closing off the opening 6.

Several operations then start almost simultaneously: step 30 represents the displacement of the extrusion ram 14 for pushing the resin out of the accumulation chamber 12 through the opening 6; step 32 represents the displacement of the parts of the central core 7; step 33 represents the preblowing with a slight air pressure through the duct 17; and step 34 represents the transfer of material through the extrusion orifice 28.

More precisely, in step 32, the central rod 11 is firstly moved, which engages through the extrusion die 25 in the mold 24, being coated with a uniform layer of resin 38. The central rod 11 advances at a speed twice the speed with which the resin 35 is output through the extrusion orifice 28, thereby axially stretching the layer of resin 38 and introducing a corresponding molecular orientation thereof. An end portion of the central rod 11 has a helical groove 39 over its peripheral surface, which impresses a corresponding helical rib on the inner surface of the layer of resin 38, as may be seen in FIG. 3. The slightly air-retarded preblowing through the duct 17 in the rod 11 detaches the layer of resin 38 from the rod 11, after a certain axial displacement thereof beyond the constriction 37, preventing the resin from being cooled too rapidly. The layer of resin 38 detached from the rod 11 is shown in FIG. 4, in which the helical rib 40 is also shown. During the preblowing step, the layer of resin 38 does not come into contact with the peripheral wall of the cavity 36.

Behindhand on the central rod 11, the sizing sleeve 10 is also moved toward the extrusion orifice 28. The sizing sleeve 10 penetrates the gap between the rod 11 and the peripheral wall of the extrusion orifice 28. The sizing sleeve 10 has an external thread 41, better seen in FIG. 2, which impresses a corresponding thread onto the inner surface of the layer of resin 38. The sizing sleeve 10 moves down to the constriction 37 of the mold 24, so as to form an internal thread 67 in the neck of the hollow body during manufacture. For example, the ratio of the internal radius of the extrusion orifice 28 to the gap is about 10.

While the rod 11 is completing its movement down to the bottom wall 42 of the internal cavity 36, the ram 14 and the inner sleeve 8 move until touching the rim 5 in order to completely empty the accumulation chamber 12. Finally, the compacting sleeve 9 slides tightly between the sizing sleeve 10 and the peripheral wall of the extrusion orifice 28 down to the lower end of the extrusion orifice 28, so as to completely expel the resin from the extrusion die 25 and to compress the material in the interstice between the sizing sleeve 10 and the constriction 37. The end-of-travel position of the various parts at the end step 32 is shown in FIG. 5.

After this situation, the blowing step 43 is carried out with a high air pressure, which makes the layer of resin 38 expand transversely until it comes into contact with the walls of the internal cavity 36 and thus completes the biaxial molecular orientation of the material and the formation of a hollow body 50. For example, the blow ratio, that is to say the ratio of the diameter of the extruded parison to the diameter of the hollow body 50, is about 3/4. Simultaneously, step 44, of returning the extrusion ram 14 into the retracted position, and then step 45, of returning the parts of the central core 7 into the retracted position, are carried out. Thus, the parison is supported until it has been finalized. In step 45, the sizing sleeve 10 is rotated so as to unscrew its external thread 41 from the corresponding thread formed on the inner surface of the layer of resin 38. To do this, the central rod 11 is coupled to a numerical-control rotary electric motor and the sizing sleeve 10 is coupled to the central rod 11 via a unidirectional pawl drive 66, which allows the sizing sleeve 10 to be driven in the unscrewing direction and also allows the sizing sleeve 10 to rotate more quickly than the central rod 11, and this prevents force being applied on the molded thread during retraction of the sizing sleeve 10.

Step 46 represents the closure of the cover for closing off the opening 6. Step 47 represents the cooling of the hollow body 50 down to the glass transition temperature of the material and below it. Step 48 represents the corresponding plastication of the hollow body 50. Next, step 49 represents the opening movement of the mold 24 for ejecting the finished hollow body 50. Step 51 represents the unlocking of the turntable and step 52 the movement of the turntable in order to bring the accumulator 1 back to the injection station 16.

Preferably, several identical accumulators will be provided in a known manner, these working simultaneously, in parallel, at the various stations. In this case, step 53 represents an initialization step of the module for controlling the molding machine so as to start a new cycle with another prefilled accumulator 1. As can be seen in FIG. 8, the work cycle at the station 2 lasts about 15 s. Steps 52 and 23b are in fact a repetition of steps 22 and 23 that inaugurates this new cycle, which will be carried out in an identical manner to that just described.

The hollow body 50 obtained by the method just described has a uniform wall thickness, a helical rib 40 over its inner surface, which increases its pressure resistance, and an internal thread in its neck. Other forms of ribs may be obtained in a similar manner, by modifying the path of the groove or grooves on the central rod 11. For example, a plurality of parallel peripheral annular grooves produces a plurality of parallel annular ribs in the hollow body 50, and parallel axial grooves produce axial ribs in the hollow body 50.

In step 32, the ratio of the speed of the central rod 11 to the output speed of the resin 35 through the extrusion orifice 28 controls the axial stretch ratio of the layer of resin 38 and can be chosen according to the desired properties. This stretch ratio is equal to 2 in the example described above.

A second embodiment of the manufacturing method according to the invention and a corresponding variant of the molding machine will now be described with reference to FIG. 6. The same reference numerals are used to denote identical or similar elements to those of the first embodiment.

As can be seen in FIG. 6, in the blowing mold 24 the internal cavity 36 has a shoulder face 54 at right angles to the wall of the constriction 37. FIG. 6 also shows annular ducts 55 for the circulation of a heat-transfer fluid in the extrusion die 25 and in the constriction 37, so as to regulate the temperature of the resin in these regions.

During the blowing step, since pressure injection takes place through that end of the central rod 11 lying at the bottom of the mold 24, the layer of resin 38 is pressed against the walls of the cavity 36 from the bottom of the mold upward. The right-hand half of FIG. 6 shows the layer of resin 38 substantially as obtained during the blowing step 43 in the first embodiment. In the second embodiment, the sizing sleeve 10 and the compacting sleeve 9 both continue to move toward the interior of the mold 24 during the blowing step. Thus, a flat 56 on the layer of resin 38, which is adjacent to an end portion 58 attached to the sizing sleeve 10, is driven a certain distance away from the shoulder face 54 and is thus folded toward a lower portion 57 of the layer of resin 38, which is attached to the peripheral wall of the cavity 36. The flat 56 remains more flexible than the remainder of the layer of resin 38 since the absence of contact with the mold 24 and the coating mandrel slows down the rate at which it cools.

The left-hand half of FIG. 6 shows the flat, with the reference 56a, approximately in its position when the sleeves 9 and 10 reach the end of their travel. In this embodiment, the compacting sleeve 9 also sweeps over the constriction 37 of the blowing mold 24 and the threaded part of the sizing sleeve 10 enters the main cavity of the mold 24. Finally, the blowing operation is completed with higher pressure, which turns down the folded flap against the end portion 58, as shown by the reference 56b, forming a right-angle bend of material. A neck with a double wall and an internal thread is thus obtained. The rest of the method is identical to the first embodiment.

The hollow bodies obtained by the methods described above may have many applications, for example for water treatment, for filtration or for the packaging of chemical, food, pharmaceutical or cosmetic products. Hollow bodies of large capacity, for example 200 liters, may be manufactured. In particular, it is possible to manufacture hollow bodies resistant to high internal pressures, because of the quality of their walls and the presence of reinforcing ribs on their inner surface, for example an aerosol bomb body designed to withstand a pressure of 30 to 35 bar. The wall thickness is controlled by the width of the gap existing around the central rod 11 in the extrusion orifice 28.

FIG. 7 shows an alternative embodiment of the central rod 11, in which it has two portions 11a and 11b having a smaller diameter than the rest of the rod 11, in order to form, by coating, a parison with a stepped thickness, and thus to obtain a hollow body having a stepped peripheral wall as regards its thickness and/or its diameter. The thinned portions 11a and 11b are thus used to obtain a greater wall thickness at the bottom and top of the hollow body 50, these being regions where the greatest pressure is exerted when the hollow body is employed as a pressurized container.

### EXAMPLE

FIG. 9 shows a hollow body 60 obtained by means of the device according to the second embodiment described and used as a container for a portable fire extinguisher 61. The hollow body 60 is manufactured from a polymer resin crosslinked by ionic bonds, this resin being known by the brand name Surlyn and manufactured by DuPont®. This material exhibits excellent transparency, good scratch resistance, a wide processing temperature range and very good resistance to organic solvents. The wall 62 has a substantially uniform thickness e that varies between 3 and 5 mm, in order to withstand a pressure of 55 bar. Its inner surface has a helical rib 63. The neck 64 of the hollow body 60 has a double wall and an internal thread for an expulsion device 65 to be screwed onto it.

1. A method of manufacturing a biaxially oriented hollow body (50) by the extrusion blow molding of a thermoplastic resin, comprising the steps consisting in:
bringing said resin (35) into a malleable state;
filling an accumulator (1) with a predetermined quantity of said resin, said accumulator comprising an accumulation chamber (12) defined between a central core (7) and an outer wall (3) having an end opening (6);
regulating the temperature of the resin in said accumulator from both faces of the accumulation chamber;
placing (22) a blowing mold (24) with an internal cavity (36) having an open constriction (37) in communication with said end opening;
axially displacing (32) a moveable mandrel (10, 11) from said central core through said accumulation chamber, said end opening and said constriction of the internal cavity, so as to coat a portion of the mandrel projecting from said central core with a layer of resin (38);
continuing (32) the axial displacement of the moveable mandrel in said internal cavity (36) at least as far as an intermediate level between said open constriction and an opposite end wall (42) of said internal cavity, simultaneously pushing (30) said predetermined quantity of resin out of said accumulation chamber with an output speed that is lower than the displacement speed of the mandrel, in order to stretch said layer of resin (38) axially;
applying (43) fluid pressure to said inner surface of the layer of resin through said mandrel in order to stretch said layer of resin transversely as far as the walls of said internal cavity and obtain a biaxially oriented hollow body (50) having a neck corresponding to the constriction of the internal cavity; and
letting said hollow body cool (47) down to a rigid state, retracting (45) said mandrel and ejecting (49) said hollow body from the blowing mold.

2. The method as claimed in claim 1, characterized by the step consisting in impressing an external relief (39, 41) of the projecting portion of said mandrel (11) onto an inner surface of said layer of resin (38) so as to obtain a hollow body having a corresponding internal relief (40, 67).

3. The method as claimed in claim 2, characterized in that said external relief includes at least one threaded mandrel portion (10) for obtaining a corresponding thread (67) on the inner surface of said hollow body.

4. The method as claimed in claim 3, characterized in that said moveable mandrel comprises a peripheral sleeve (10) that constitutes said threaded mandrel portion and a central rod (11) that can slide axially relative to said peripheral sleeve, and in that, in the displacement step of the mandrel (32), said peripheral sleeve (10) is brought into said constriction (37) of the internal cavity so as to clamp said layer of resin (38) between said threaded mandrel portion and a wall of said constriction, and in that, in the retraction step (45) of the mandrel, said peripheral sleeve (10) is made to undergo an axial rotational movement so as to disengage said peripheral sleeve from the internal thread (67) obtained in a constriction of the hollow body.

5. The method as claimed in claim 4, characterized by the steps consisting in: displacing the peripheral sleeve (10 from the constriction (37) toward the interior of the internal cavity (36) during the blowing step (43), so as to fold a flat (56) of said layer of resin (38) between a portion (57) of said layer of resin pressed against the wall of the internal cavity of the blowing mold and an end portion (58) of said layer of resin fastened to the peripheral sleeve; and pressing said folded flat (56a, 56b) against said end portion (58) of said layer of resin fastened to the peripheral sleeve at the end of the blowing step.

6. The method as claimed in claim 1, characterized in that said end opening (6) of the accumulator and said constriction (37) of the blowing mold communicate through an extrusion orifice (28) of an extrusion die (25), and in that a compacting sleeve (9) is moved around said mandrel (10, 11) in said extrusion orifice, said compacting sleeve being inserted between said mandrel and a wall of said extrusion orifice (28) so as to completely remove the resin from the extrusion orifice in the internal cavity (36) of the blowing mold.

7. The method as claimed in claim 1, characterized in that, in the displacement step (32) of the moveable mandrel, the accumulation chamber (12) is completely emptied through the extrusion orifice (28).

8. The method as claimed in 4 claim 1, characterized in that said mandrel (11) is displaced substantially as far as the end wall (42) of the internal cavity.

9. A device for implementing the method as claimed in claim 1, comprising:
a resin accumulator (1) that includes an outer wall (3) and a central core (7) that define, between them, an accumulation chamber (12) capable of receiving a predetermined quantity of thermoplastic resin (35) in a malleable state, an end opening (6) made through said outer wall, an extrusion ram (14) arranged so as to slide between said outer wall and said central core in order to expel said predetermined quantity of resin from said accumulation chamber through said end opening;
a biaxial-orientation blowing mold (24) with an internal cavity (36) having an open constriction (37) that can be placed opposite said end opening and an end wall (42) on the opposite side from said open constriction;
a mandrel (10, 11) that can move axially between a retracted position inside said central core (7) and projection positions, in which positions a portion of said mandrel projecting from said central core is engaged through said end opening and said constriction of the internal cavity, said mandrel having an axial internal duct (17) opening onto the outside of said mandrel at said projecting portion and a valve (18, 19) for selectively opening and closing said internal duct;
controlled drive means for selectively displacing, so as to slide axially, said extrusion ram and said mandrel; and
a pressure source connected to said internal duct of the mandrel, characterized in that the outer wall (3) of the accumulator is provided with a heating means (21), in that the central core (7) of the accumulator is provided with an internal circuit (13) intended for the circulation of a heat-transfer fluid and in that said mandrel (11) can move in said internal cavity (36) at least as far as an intermediate level between said constriction (37) and said end wall (42).

10. The device as claimed in claim 9, characterized in that said mandrel (11) has at least one groove (39) for obtaining a rib (40) of corresponding shape on the inner surface of said hollow body (50).

11. The device as claimed in claim 10, characterized in that said groove or each of said grooves (39) follows a closed annular path or a substantially linear axial path or a helical path.

12. The device as claimed in claim 9, characterized in that said mandrel includes at least one threaded mandrel portion (10) for obtaining a corresponding thread on the inner surface of said hollow body.

13. The device as claimed in claim 12, characterized in that said moveable mandrel comprises a peripheral sleeve (10) that constitutes said threaded mandrel portion and a central rod (11) that can slide axially relative to said peripheral sleeve, and in that said drive means are capable of axially displacing said central rod and said peripheral sleeve so as not to be in phase and of rotating at least said peripheral sleeve in the unscrewing direction of the thread of the peripheral sleeve.

14. The device as claimed in claim 13, characterized in that the central rod is rotated axially by said drive means, a unidirectional coupler being placed between said peripheral sleeve and said central rod in order to rotationally couple said peripheral sleeve to said central rod in said unscrewing direction and to rotationally decouple said peripheral sleeve from said central rod in the opposite direction.

15. The device as claimed in claim 9, characterized in that said end opening (6) of the accumulator and said constriction (37) of the biaxial-orientation blowing mold communicate through an extrusion orifice (28) of an extrusion die (25), a compacting sleeve (9) being placed around said mandrel (10) and able to move axially between a retracted position in said central core (7) of the accumulator and a deployed position, in which position said compacting sleeve is inserted between said mandrel and a wall of said extrusion orifice so as to completely remove the resin from the extrusion orifice in the internal cavity (36) of the biaxial-orientation blowing mold.
